(19) United States
(12) Patent Application Publication
(10) Pub. No.: US 2020/0221378 A1
(43) Pub. Date: Jul. 9, 2020

(54) Active Scanning Enhancements for Multi-Band and Multi-Basic Service Set Discovery

(71) Applicant: Apple Inc., Cupertino, CA (US)

(72) Inventors: Jarkko L. Kneckt, Los Gatos, CA (US); Guoqing Li, Cupertino, CA (US); Yong Liu, Campbell, CA (US); Christiaan A. Hartman, Mountain View, CA (US)

(21) Appl. No.: 16/591,140

(22) Filed: Oct. 2, 2019

Related U.S. Application Data
(60) Provisional application No. 62/789,201, filed on Jan. 7, 2019.

(51) Int. Cl. H04W 48/20; H04W 48/14

(52) U.S. Cl. CPC H04W 48/20; H04W 84/12; H04W 48/14

(57) ABSTRACT

Methods and devices for implementing enhanced probe messaging over a wireless local area network. A user equipment (UE) may transmit a probe request message to a wireless access point (AP) through a wireless local area network (WLAN), wherein the probe request message requests one or more parameters of a response message. The UE may receive the response message as a probe response message or a beacon message from the first AP, and the response message may include information related to one or more basic service sets (BSSs). The information related to the one or more BSSs is determined at least in part based on the requested one or more parameters of the probe request message. The UE may establish a connection with a first BSS of the one or more BSSs based at least in part on the information comprised within the probe response message or the beacon message.

### PRIORITY CLAIM

This application claims priority to U.S. Provisional Patent Application No. 62/789,201, titled “Active Scanning Enhancements for Multi-Band and Multi-Basic Service Set Discovery” and filed on Jan. 7, 2019, which is hereby incorporated by reference in its entirety, as though fully and completely set forth herein.

### TECHNICAL FIELD

The present application relates to wireless communication, including to techniques for utilizing enhanced probe messaging over a wireless local area network.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices, or user equipment devices (UEs) may take the form of smart phones or tablets that access wireless local area networks (WLANs). In many environments, a large number of WLAN access points may be available, and it may be a time and energy intensive process for a UE to determine the most desirable wireless access point upon which to connect. Therefore, improvements in the field are desired.

### SUMMARY

Embodiments are presented herein of, inter alia, systems, apparatuses, and methods for utilizing enhanced probe messaging over a wireless local area network.

A user equipment device (UE) may comprise an antenna, a radio operably coupled to the antenna. and a processing element operably coupled to the radio. The UE may be configured to communicate over a wireless local area network with a wireless access point (AP).

In some embodiments, the UE may transmit a probe request message to the AP through the wireless local area network (WLAN), wherein the probe request message requests one or more parameters of a probe response message.

The UE may receive the probe response message from the first AP, wherein the probe response message comprises information related to one or more basic service sets (BSSs), and wherein the information related to the one or more BSSs is determined at least in part based on the requested one or more parameters of the probe request message.

The UE may establish a connection with a first BSS of the one or more BSSs based at least in part on the information comprised within the probe response message.

The techniques described herein may be implemented in and/or used with a number of different types of devices, including but not limited to cellular phones, tablet computers, accessory and/or wearable computing devices, portable media players, cellular base stations and other cellular network infrastructure equipment, servers, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a user equipment device (UE), according to some embodiments;

FIG. 2 is a block diagram illustrating an example UE, according to some embodiments;

FIG. 3 is a block diagram illustrating an example wireless access point, according to some embodiments;

FIG. 4 is an example format of a probe request frame including a 6 GHz band request, according to some embodiments;

FIG. 5 is an example format of a probe request frame emphasizing a channel specific field, according to some embodiments;

FIG. 6 is an example format of a reduced neighbor report (RNR) element, according to some embodiments; and

FIG. 7 is a communication flow diagram illustrating an exemplary method for performing enhanced probe messaging over a wireless local area network (WLAN), according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Terminology

The following are definitions of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™ PlayStation Portable™, Gameboy Advance™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer system devices which performs wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” (also called “eNB” or “gNB”) has the full breadth of its ordinary meaning, and at least includes a wireless communication station installed at a fixed location and used to communicate as part of a wireless cellular communication system.

Link Budget Limited—includes the full breadth of its ordinary meaning, and at least includes a characteristic of a wireless device (a UE) which exhibits limited communication capabilities, or limited power, relative to a device that is not link budget limited, or relative to devices for which a radio access technology (RAT) standard has been developed. A UE that is link budget limited may experience relatively limited reception and/or transmission capabilities, which may be due to one or more factors such as device design, device size, battery size, antenna size or design, transmit power, receive power, current transmission medium conditions, and/or other factors. Such devices may be referred to herein as “link budget limited” (or “link budget constrained”) devices. A device may be inherently link budget limited due to its size, battery power, and/or transmit/receive power. For example, a smart watch that is communicating over LTE or LTE-A with a base station may be inherently link budget limited due to its reduced transmit/receive power and/or reduced antenna. Wearable devices, such as smart watches, are generally link budget limited devices. Alternatively, a device may not be inherently link budget limited, e.g., may have sufficient size, battery power, and/or transmit/receive power for normal communications over LTE or LTE-A, but may be temporarily link budget limited due to current communication conditions, e.g., a smart phone being at the edge of a cell, etc. It is noted that the term “link budget limited” includes or encompasses power limitations, and thus a power limited device may be considered a link budget limited device.

Processing Element (or Processor)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

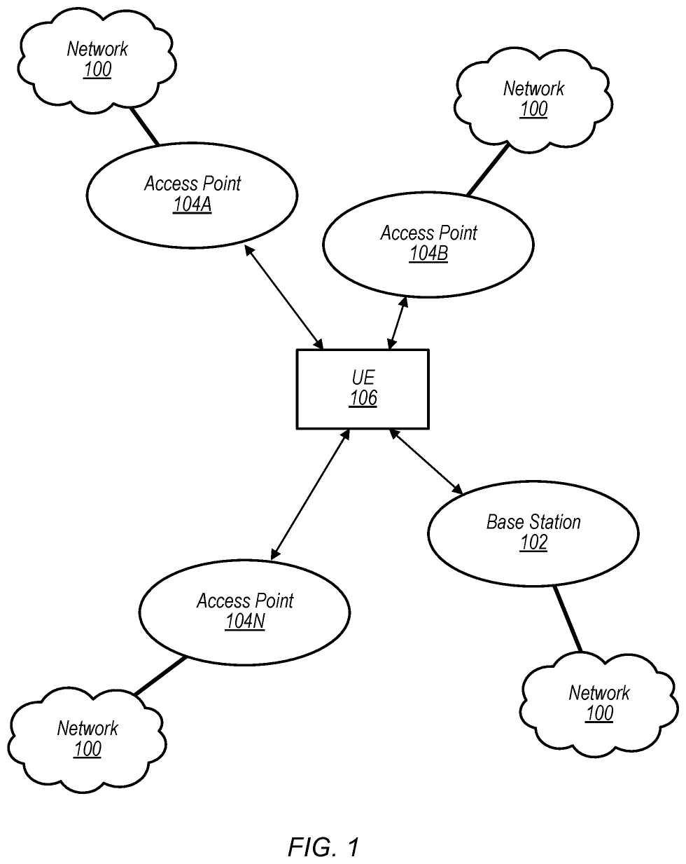

### FIG. 1—Wireless Communication System

FIG. 1 illustrates an example of a wireless cellular communication system. It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown, the exemplary wireless communication system includes a plurality of wireless access points (APs) 104A-104N, which communicate over a wireless local area network (WLAN) with a wireless device 106. The wireless device 106 may be a user device, which may be referred to herein as “user equipment” (UE), or a UE device.

Note that at least in some instances a UE device 106 may be capable of communicating using any of a plurality of wireless communication technologies. For example, a UE device 106 might be configured to communicate using one or more of GSM, UMTS, CDMA2000, LTE, LTE-A, 5G NR, WLAN, Wi-Fi, IEEE802.11, Bluetooth, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances a UE device 106 may be configured to communicate using only a single wireless communication technology.

As shown, the exemplary wireless communication system also includes a plurality of WLAN APs 104A-N, which communicate over a transmission medium with the wireless device 106. The WLAN AP, which may be a Wi-Fi AP, also provides communicative connectivity to the network 100. Each of the WLAN APs (which may be more concisely referred to herein as “APs”) may communicate within one or more different WLAN frequency bands, such as 2.4 GHz, 5 GHz, and/or 6 GHz, among other possibilities. Thus, according to some embodiments, wireless devices may be able to connect to one or more of the access points 104A-N and/or the base station 102 (or another cellular base station) to access the network 100 at a given time.

The UE 106 may include a handheld device such as a smart phone or tablet, and/or may include any of various types of device with cellular communications capability. For example, the UE 106 may be a wireless device intended for stationary or nomadic deployment such as an appliance, measurement device, control device, etc.

The UE 106 may include a device or integrated circuit for facilitating cellular communication, referred to as a cellular modem. The cellular modem may include one or more processors (processor elements) and various hardware components as described herein. The UE 106 may perform any of the method embodiments described herein by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The cellular modem described herein may be used in a UE device as defined herein, a wireless device as defined herein, or a communication device as defined herein. The cellular modem described herein may also be used in a base station or other similar network side device.

The UE 106 may include one or more antennas for communicating using two or more wireless communication protocols or radio access technologies. In some embodiments, the UE device 106 might be configured to communicate using a single shared radio. The shared radio may couple to a single antenna, or may couple to multiple antennas (e.g., for MIMO) for performing wireless communications. Alternatively, the UE device 106 may include two or more radios. Other configurations are also possible.

The UE 106 may be further configured to wirelessly communicate with a cellular base station 102, which may also be equipped to communicate with the network 100 (e.g., a core network of a cellular service provider, a telecommunication network such as a public switched telephone network (PSTN), and/or the Internet, among various possibilities). Thus, the base station 102 may facilitate communication among the UE devices 106 and/or between the UE devices 106 and the network 100. In other implementations, base station 102 can be configured to provide communications over one or more other wireless technologies, such as an access point supporting one or more WLAN protocols, such as 802.11 a, b, g, n, ac, ad, and/or ax, or LTE in an unlicensed band (LAA).

The communication area (or coverage area) of the base station 102 may be referred to as a “cell.” The base station 102 and the UEs 106 may be configured to communicate over the transmission medium using any of various radio access technologies (RATs) or wireless communication technologies, such as GSM, UMTS (WCDMA, TDS-CDMA), LTE, LTE-Advanced (LTE-A), 5G NR, HSPA, 3GPP2 CDMA2000 (e.g., 1×RTT, 1×EV-DO, HRPD, eHRPD), Wi-Fi, WiMAX etc.

Base station 102 and other similar base stations (not shown) operating according to one or more cellular communication technologies may thus be provided as a network of cells, which may provide continuous or nearly continuous overlapping service to the UE device 106 and similar devices over a geographic area via one or more cellular communication technologies.

The UE 106 and/or one or more of the APs 104 may be configured to perform any of the methods disclosed herein, e.g., to perform network probing.

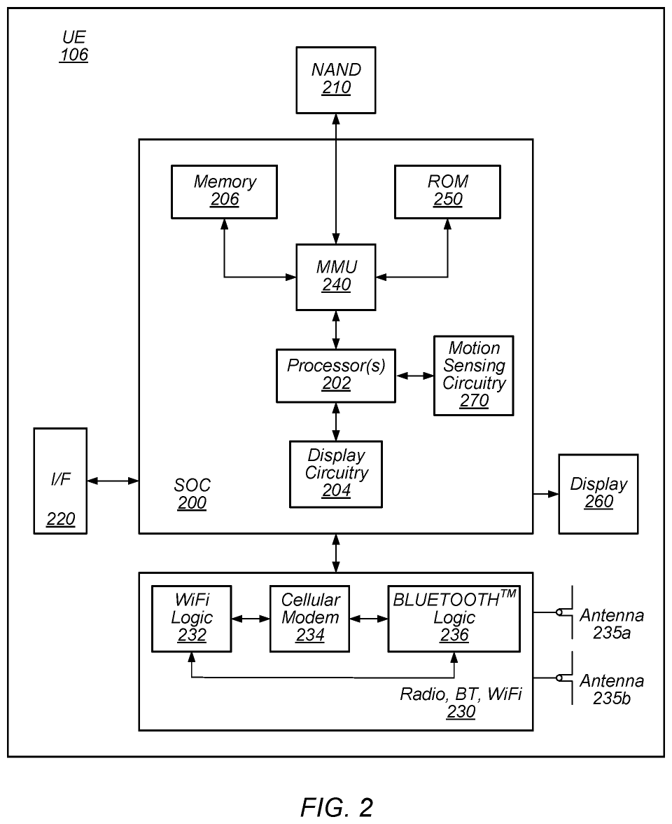

### FIG. 2—Example Block Diagram of a UE Device

FIG. 2 illustrates one possible block diagram of a UE device, such as UE device 106. As shown, the UE device 106 may include a system on chip (SOC) 200, which may include portions for various purposes. For example, as shown, the SOC 200 may include processor(s) 202 which may execute program instructions for the UE device 106, and display circuitry 204 which may perform graphics processing and provide display signals to the display 260. The SOC 200 may also include motion sensing circuitry 270 which may detect motion of the UE 106, for example using a gyroscope, accelerometer, and/or any of various other motion sensing components. The processor(s) 202 may also be coupled to memory management unit (MMU) 240, which may be configured to receive addresses from the processor(s) 202 and translate those addresses to locations in memory (e.g., memory 206, read only memory (ROM) 250, flash memory 210). The MMU 240 may be configured to perform memory protection and page table translation or set up. In some embodiments, the MMU 240 may be included as a portion of the processor(s) 202.

As shown, the SOC 200 may be coupled to various other circuits of the UE 106. For example, the UE 106 may include various types of memory (e.g., including NAND flash 210), a connector interface (I/F) 220 (e.g., for coupling to a computer system, dock, charging station, etc.), the display 260, and wireless communication circuitry 230 (e.g., for LTE, LTE-A, NR, CDMA2000, Bluetooth, Wi-Fi, NFC, GPS, etc.).

The UE device 106 may include at least one antenna, and in some embodiments, multiple antennas 235a and 235b, for performing wireless communication with base station 102, wireless access points 104, and/or other devices. For example, the UE device 106 may use antennas 235a and 235b to perform the wireless communication. As noted above, the UE device 106 may in some embodiments be configured to communicate wirelessly using a plurality of wireless communication standards or radio access technologies (RATs). When the UE 106 is in communication with a wireless access point 104 over a WLAN network, the UE 106 may be referred to as a wireless station, or “STA”.

The wireless communication circuitry 230 may include Wi-Fi Logic 232, a Cellular Modem 234, and/or Bluetooth Logic 236. The Wi-Fi Logic 232 is for enabling the UE device 106 to perform Wi-Fi or other WLAN communications on an 802.11 network. The Bluetooth Logic 236 is for enabling the UE device 106 to perform Bluetooth communications. The cellular modem 234 may be a cellular modem capable of performing cellular communication according to one or more cellular communication technologies.

As described herein, UE 106 may include hardware and software components for implementing embodiments of this disclosure, e.g., to perform network probing according to any of the methods disclosed herein. For example, one or more components of the wireless communication circuitry 230 (e.g., Wi-Fi logic 232, cellular modem 234, Bluetooth logic 236) of the UE device 106 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

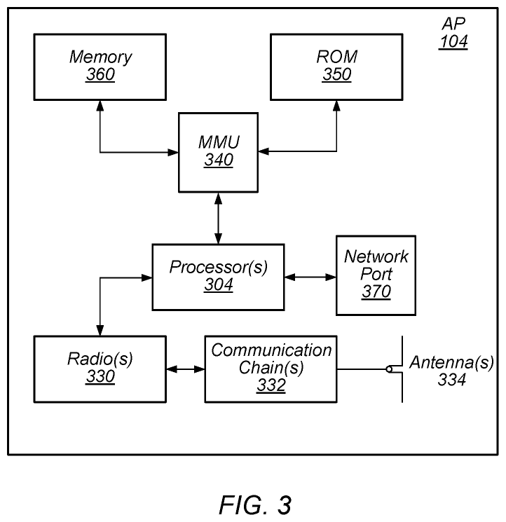

### FIG. 3—Block Diagram of a WLAN Access Point

FIG. 3 illustrates an example block diagram of a WLAN access point (AP) 104, according to some embodiments. It is noted that the AP of FIG. 3 is merely one example of a possible AP. As shown, the AP 104 may include processor(s) 304 which may execute program instructions for the access point 104. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The AP 104 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

The AP 104 may include at least one wireless transceiver, which may include one or more radios 330, one or more communication chains 332 and one or more antennas 334. The wireless transceiver and may be further configured to communicate with UE device 106. Communication chain 332 may be a receive chain, a transmit chain, or both. The radio 330 may be configured to communicate via various wireless communication standards, including, but not limited to, LTE, LTE-A, NR, GSM, UMTS, CDMA2000, Wi-Fi, etc. Each of the antennas 334 may be configured to operate within a different frequency band, a different radio access technology, and/or within a separate WLAN network, in some embodiments.

The AP 104 may be configured to communicate wirelessly using multiple wireless communication standards. For example, as one possibility, the AP 104 may include an LTE or 5G NR radio for performing communication according to LTE or 5G NR, as well as a Wi-Fi radio for performing communication according to Wi-Fi. In such a case, the AP 104 may be capable of operating as both an LTE base station and a Wi-Fi access point. As another possibility, the AP 104 may include a multi-mode radio which is capable of performing communications according to any of multiple wireless communication technologies (e.g., NR and Wi-Fi, NR and UMTS, LTE and CDMA2000, UMTS and GSM, etc.). As still another possibility, the AP 104 may be configured to act exclusively as a Wi-Fi access point, e.g., without cellular communication capability.

In some embodiments the AP 104 may be configured to provide one or more basic service sets (BSSs). For example, the AP 104 may service a single BSS identified by a BSS identifier (BSSID). Alternatively, the AP 104 may comprise a multi-BSS AP that services multiple BSSs on separate channels, each with their own respective BSSID. Each of the BSSs of a multi-BSS AP may operate in a separate channel with a separate service set identifier (SSID).

As described further subsequently herein, the AP 104 may include hardware and software components for implementing or supporting implementation of features described herein, e.g., to support network probing according to any of the methods disclosed herein. The processor(s) 304 of the access point 104 may be configured to implement or support implementation of part or all of the methods described herein, e.g., by executing program instructions stored on a memory medium (e.g., a non-transitory computer-readable memory medium). Alternatively, the processor(s) 304 may be configured as a programmable hardware element, such as an FPGA (Field Programmable Gate Array), or as an ASIC (Application Specific Integrated Circuit), or a combination thereof. Alternatively (or in addition) the processor 304 of the AP 104, in conjunction with one or more of the other components 330, 332, 334, 340, 350, 360, and/or 370, may be configured to implement or support implementation of part or all of the features described herein.

### Active Scanning Enhancements for Multi-BSS Discovery

Due to the large amount of data traffic that is transferred over wireless local area networks (WLANs), next generation WLAN networks are currently in development under the IEEE 802.11ax Standard (hereinafter “11ax”) that will utilize the 6 GHz band for increased throughput potential. Due to the wide bandwidth on 6 GHz (>1 GHz), discovering wireless access points (APs) operating on 6 GHz may take a longer period of time relative to other bands (e.g., 2.4 GHz and/or 5 GHz). To address this issue, 11ax has incorporated a mechanism to use a Reduced Neighbor Report (RNR) element transmitted on 2.4/5 GHz to advertise any/all APs on the 6 GHz band. The RNR may be carried in any of a Beacon frame, a FILS Discovery frame, and/or a probe response frames on 2.4/5 GHz. The RNR may carry one or more of the following types of information:

1. Neighbor AP Band/Channel

2. Neighbor AP target beacon transmission time (TBTT)

3. Short service set identifier (short SSID) (this may be optionally present and may be a compressed version of the full SSID, or network name)

4. Basic service set identifier (BSSID) (this may be optionally present)

The Short SSID may be a compressed version of the full SSID (e.g., the traditional SSID or network name). For example, a specific CRC function may be applied to the full SSID to obtain the Short SSID. A full SSID may have a length of, e.g., up to 32 bytes. After compression, the Short SSID may have a length of, e.g., 4 bytes, thus significantly reducing the amount of data used to identify the service set. In other implementations, the Short SSID may have other lengths, such as 1-5 bytes, 5-10 bytes, etc. However, in at least some instances, the compression process may result in information loss, such that recovering the full SSID may not be possible based on the Short SSID.

For that reason, a STA, such as the UE 106, may store a list of known and/or preferred networks, with the list including both the full SSID and the Short SSID. For example, in some scenarios, the STA may apply the applicable cyclic redundancy code (CRC) function to a known full SSID (e.g., stored on the list of known/preferred networks), and may store the resulting Short SSID on the list.

However, in some scenarios, the STA may receive from an AP a beacon or other message identifying a new service set that is not stored on the list (or does not match an identifier stored in the list). In such scenarios, the STA may send a probe request to the AP, requesting additional information regarding the service set, e.g., to determine whether the STA is capable of joining the service set. However, if the beacon or other message identifies the new service set only by the Short SSID (e.g., if the message does not include the corresponding full SSID), then the STA may be unable to identify the service set by its full SSID in the probe request.

In some embodiments, a wireless AP may have multiple radios and may be configured to operate within multiple networks, frequency bands, channels, and/or radio access technologies (RATs). For example, a single wireless AP may be a multi-BSS AP that services multiple BSSs as “virtual APs”.

The active scanning and fast passive scanning techniques envisioned for flax are designed for APs hosting a BSS in the scanned band. Multi-band and multi-BSS features are specified in 802.11v, but scanning rules are not optimized for these features. A multi-BSS AP hosts two or more BSSs that have the same primary channel and share the same Beacon. A multi-band AP may have two or more radios and is capable of operating BSSs in multiple bands. For example, a multi-band AP may have a BSS operating in the 2.4 GHz band, a BSS operating in the 5 GHz band and/or a BSS operating in the 6 GHz band.

For instance, active scanning is channel specific, such that the scanning STA may not be able to specify the type of scanning information it desires to receive. For example, it may be desirable for the STA to obtain a multiple BSSID element from the AP, co-hosted BSS information from different channels, and/or scanning hints to detect neighboring APs. For example, an AP may only provide a multiple BSSID element if the STA happens to transmit a Probe Request to the transmit MAC address of the AP.

A STA may select a channel for scanning to find a suitable AP to connect upon. The first channel may be selected by random or by implementation specific logic. In some embodiments, the first channel is at the 2.4 or 5 GHz bands. The discovered APs may provide more information of the available BSSs serviced by the same AP, at the scanned channel. The scanning STA may use this information to select a suitable BSS for association, or to determine the next channel to be scanned. However, tools to request and respond with more precise information of available BSSs are not currently developed, and the information provided to the scanning STA may not precisely confirm with what the scanning STA needs to effectively establish a desirable connection.

To get more information of the candidate BSS, the 802.11ax Standard has proposed implementing a scan (e.g. an active or passive scan) at the channel where the candidate BSS/AP is operating. The STA may perform out-of-the-band discovery, whereby a request is made through other APs for more information and/or a probe response of the candidate AP.

In some embodiments, the STA may continue to scan until the STA finds and associates with a suitable BSS, the STA has scanned all channels and lists available BSSs for the end-user, or the STA has scanned all channels and selects to utilize a different radio and/or radio access technology (RAT).

Scanning methodologies currently in development may lack a means to request or to provide the following types of information in active scanning:

1. Responding to a Probe Request if the AP hosts a BSS with a matching SSID but at a different channel.

2. Responding with a Multiple BSSID element, unless AP receives a Probe Request at the corresponding transmit MAC address or to an SSID matching the transmit MAC address.

3. Requesting or indicating that the AP has provided all hosted SSIDs or channels in which the AP hosts BSSs.

4. Requesting BSS information that is hosted in a specific band such as the 2.4, 5 or 6 GHz band, or only at the channel in which the request was received

5. Indicating that the response provides all hosted SSIDs or channels in which the AP hosts BSSs

6. Requesting a minimum response only on the requested BSSs at the scanned channel.

Embodiments herein present enhanced scanning methodologies that enable requesting and/or provisioning for one or more of the types of information listed above. Currently, an AP responds to a Probe Request only if it has a BSS operating in the channel which matches with the requested SSID or BSSID, or BSS capabilities matching with the requested capabilities. If a STA desires to operate in a specific SSID, but the AP does not have the BSS with the requested SSID operating in the scanned channel, then the AP may not respond to broadcast probe requests that request the specific SSID, even if it could provide the matching SSID/BSSID parameters in a RNR.

In some embodiments, the AP may respond to probe requests requesting a “star/wildcard” SSID. In this case the responding AP may not know the desired SSID of the scanning STA. Accordingly, the AP may not know for which SSID it should provide information, and the AP may not provide the desired information in its response. In the 6 GHz channel, the broadcast probe request with a wild card SSID may not be allowed, further complicating AP information sharing on BSSs it is hosting in other than the scanned channel.

If an AP receives a probe request requesting an SSID, a Short SSID or a BSSID matching a BSS which the AP operates in a different channel, the AP may respond with a Probe Response containing channel information or other identifying information regarding the BSS corresponding to the requested BSS. In these embodiments, the AP may receive the probe request through a BSS on a primary channel, and information related to the BSS operating on the primary channel may not be related to or match information related to the requested BSS.

Additionally or alternatively, the AP may include a reduced neighbor report (RNR) element(s) in the probe response message containing information on the BSS(s) whose SSID matches the requested SSID or whose BSSID matches the requested BSSID. This may increase the speed of BSS discovery by reducing the number of transmitted frames, for example, by reducing active scanning messages in different bands. In other words, the scanning STA may not need to guess the correct channel (e.g. the primary channel of the BSS).

In some embodiments, the AP may respond to a probe request with a beacon frame instead of a probe response frame. An AP typically transmits beacon frames periodically at a regular time interval. If the probe request is received just before the next beacon transmission time, the AP may respond with the next beacon frame, include the requested information in the beacon frame, and not send a separate probe response frame.

Additionally or alternatively, if an AP receives a probe request including a wildcard SSID (i.e. an SSID with zero length), or a wildcard BSSID (i.e. a 6 octet-long MAC Address that has all bits set to 1), together with specific SSID or BSSID values, the AP may include information of the BSSs matching the specific SSID or BSSID values in its response. This kind of probe request may be used in 2.4 or 5 GHz bands to request responses from all APs that received the Probe Request and to ensure that information related to the BSSs matching the specific SSIDs and BSSIDs is included to the response.

In some embodiments, if a multi-BSS AP receives a probe request requesting a response regarding a particular BSS, the AP may transmit the probe response only from the BSSID of the BSS matching the request. If the requested BSS does not match the transmit MAC address of the AP, the AP may not include the Multiple BSSID element(s) in the response. The Multiple BSSID element(s) may provide detailed information regarding other BSSs that the AP hosts in the channel and/or in other channels.

In some embodiments, if an AP receives a wildcard SSID or a wildcard BSSID, the AP transmits the probe response from the transmit MAC address and includes a Multiple BSSID element in the response.

In other embodiments, the AP may decide whether it responds from the BSSID of the BSS matching the request, or whether it responds from the transmit MAC address and includes a multiple BSSID element(s) in the response. The AP may respond on the transmit MAC address and may include a multiple BSSID element in the response, even if this is not requested in the probe request received from the STA. When the AP determines the MAC address from which the response is to be transmitted, the AP may consider whether the requesting STA is capable of receiving a multiple BSSID element, and the AP may consider the number of other scanning devices in the channel. For example, in high density areas, other scanning STAs may benefit from detailed information of BSSs hosted by the AP.

The scanning STA may indicate in the probe request whether it requests information only on the BSSs matching the request or on all BSSs. In other words, the STA may indicate whether the AP should include multiple BSSID elements and/or RNR elements on matching BSSs. A multi-BSS AP may decide whether it responds from the matching BSSID or from the transmit MAC address, and whether it includes a multiple BSSID element to provide information regarding all (or most of) the BSSs or only the requested BSSs.

In some embodiment, the probe request may indicate that the scanning STA desires to receive hints of neighboring APs. For instance, a scanning STA may have a poor link to the currently associated AP and may look for available neighbor APs.

In some embodiments, the probe response with a multiple BSSID element may offer advantages if multiple STAs are scanning. For example, a probe response with a multiple BSSID element may provide scanning information to multiple scanning STAs within a single transmitted frame.

In current implementations, an AP may not be able to indicate whether a frame includes information related to all SSIDs of the hosted BSSs. In some embodiments, this indication may be added to the RNR element. This frame may contain all SSIDs in combination with the SSIDs in multiple BSSID elements or short SSIDs in RNR elements. Examples of frames that may include all hosted SSIDs are beacon, FILS discovery and probe response frames.

In current implementations, an AP may not be able to indicate whether a frame includes all channels on which it hosts BSSs. In some embodiments, the channels in which the AP hosts BSSs, other than the channel in which the AP received the request, may be indicated in RNR element(s) added to the frame. Typical frames that may include all channels in which the AP hosts BSSs are beacon, FILS discovery and probe response frames. The scanning STAs may thereby know that they have received a complete set of hosted SSIDs or channels in which BSSs operate, and the scanning STAs may not need to request further reports from the AP, reducing traffic congestion.

In some embodiments, a STA may indicate if it is interested in receiving information only on BSSs operating in the channel in which the probe request was received or if it is not interested in receiving information of BSSs operating in a specific band or channel. The STA may not be interested in receiving information regarding BSSs in a specific band or channel for various reasons. For example, in many environments the 2.4 GHz band (or 5 GHz) band may be congested, or a STA may get better performance through other radio access technologies. As another example, an application operating on the STA may require throughput that is not achievable at 2.4 GHz, or the use of the 2.4 GHz band may be highly inefficient for the amount of data to be transmitted. As a further example, a STA may have multiple radios (e.g., BT, LTE, 5G, among other possibilities) that it is using and concurrent use of one or more of these radios may limit the usage of specific bands. To speed up active scanning, the requesting STA may limit the BSSs listed on the RNR to specific requested bands or to the channel in which the probe request was received. Alternatively, the AP may by default include information related to all BSSs, but may exclude BSSs on bands or channels that the STA indicates it is not interested in operating in. Advantageously, this may reduce the size of the probe responses, resulting in faster BSS discovery.

In some embodiments, a probe request may include a band-specific bitmap of bands from which RNR information is requested. For example, the band specific field may be set to 1 if a band specific request field is present. As one example, the band specific request may list the requested bands in the following order: 2.4 GHz, 5 GHz, followed by the 6 GHz band. Other orders are also possible.

A value of 1 in the band-specific bitmap may indicate that the scanning STA requests responses on BSSs in the band, while a value of 0 may indicate that the scanning STA does not request responses on BSSs in the band. An AP may monitor the requested BSSs and bands, and the AP may operate a BSS as requested to ensure that the requested BSS is available for the STA.

In some embodiments, if all bits in a band-specific bitmap are set to 0 in the request, the AP may provide BSS information only on the BSS whose primary channel is the channel in which the request was received.

In some embodiments, when the AP has a large number of scanning STAs, the AP may decide to respond with information of BSSs at all (or most) bands. For example, APs during rush hour at a Tokyo metro station may respond with information of BSSs at all bands, since at least one of the scanning STAs may be likely to utilize each of the BSSs.

To summarize the embodiments described above, in current implementations, scanning may not be optimized for multi-BSS APs and multi-band APs discovery. Embodiments described herein provide means to address these and other concerns by implementing enhanced probe request and scanning response messaging. For example, an AP may respond to a probe request if it matches with a BSS that the AP hosts at another channel. The AP may transmit a probe response from a MAC address that may include a multiple BSSID element, even if the BSS matching the request has a different MAC address. A frame may indicate that all hosted SSIDs and channels in which BSSs are hosted are included. Furthermore, the STA may request band specific information.

These improvements may enable fast and precise 6 GHz AP discovery, and may allow the AP to provide more information to scanning STAs. The STA may specify whether BSS information is desired on the same channel or on another channel. The probe response may indicate that the response contains all SSIDs or all channels in which the AP hosts BSSs.

### Additional Probe Request/Response Enhancements

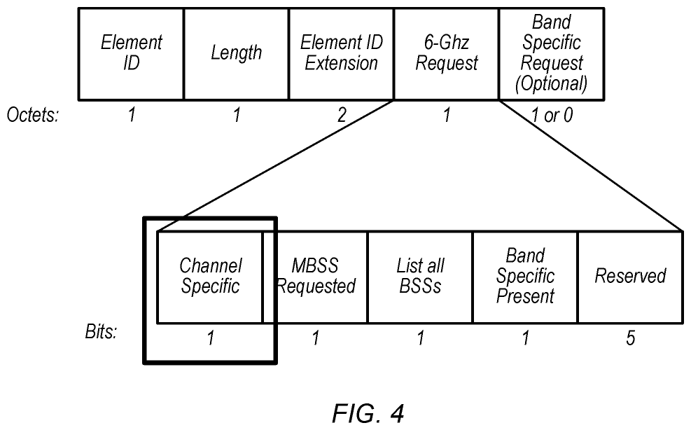

The following paragraphs describe additional enhancements to probe request/response messaging, according to various embodiments. In some embodiments, as illustrated in FIG. 4, a new information element may be added to the probe request (“6-GHz Request”) to control the probe response content on the BSSs that a multi-band AP and/or a multi-BSS AP lists in its probe response. Additionally, the multi-band APs may be allowed to provide information related to BSSs at different bands, if the BSSs match with the requested SSID or BSSID(s).

In some embodiments, if an AP receives a probe request matching a BSS which the AP operates at different channel, the AP may respond with a probe response containing information related to a BSS that does not match the request but matches the primary channel where the probe request was transmitted. Alternatively or additionally, the probe response may contain a reduced neighbor report (RNR) element containing information on the matching BSS(s) that the AP hosts and which have a different primary channel. This may result in a quicker discovery of the BSS and may reduce the number of active scanning messages in different bands, since the scanning STA may not need to guess the correct channel.

In some embodiments, and as illustrated in the boxed-in portion of FIG. 4, the scanning STA may set the “Channel Specific” field to 1 in the probe request frame to indicate that a probe response should be transmitted only if a matching BSS's primary channel is the channel in which the probe request was transmitted and the BSS matches the SSID, BSSID, or other parameters requested by the probe request. Advantageously, in high density deployments, this may enable the scanning STA to reduce the number of probe responses that are transmitted as a response to the probe request.

In some embodiments, if the AP operates a hidden BSS at a channel, the beacon may have SSID length 0. In other words, the beacon may not contain the SSID of the BSS. The hidden BSS may not be listed in a multiple BSSID element, if multiple BSSs are co-located at the same channel and at least one BSS is not hidden. In current implementations, a hidden BSS may be discovered only by sending a probe request that contains the SSID of the hidden BSS on the primary channel of the hidden BSS, whereupon the AP may transmit a probe response.

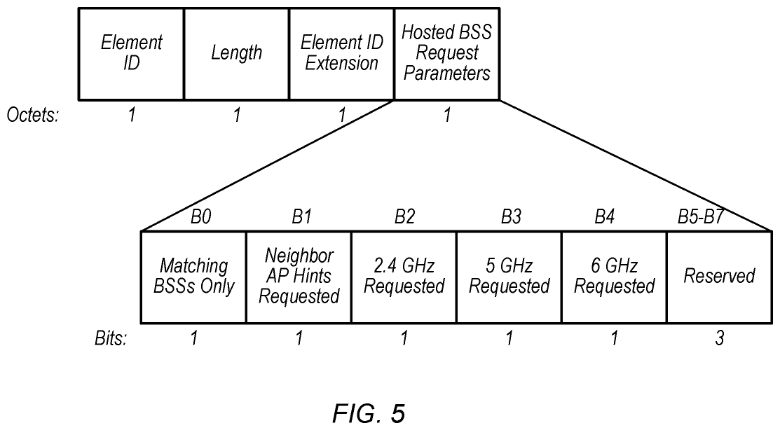

FIG. 5 illustrates another example probe request message format, according to some embodiments. As illustrated, the Matching BSSs Only subfield may be set to 1 to request that the probe response frames transmitted as a response to the probe request include information related only to BSSs requested by the probe request frame carrying the field. Further, the Matching BSSs Only subfield may be set to 0 to indicate that APs receiving the probe request message are requested to provide information of all BSSs in the probe response message. Furthermore, the Neighbor AP Hints Requested subfield may be set to 1 to indicate that responding APs are requested to include one or more RNR element(s) in the probe response message, wherein the RNR element(s) contain information related to BSSs operating on a neighboring AP (i.e., BSSs operating on a different AP from the AP sending the probe response message).

Opportunistic Wireless Encryption is an encryption mechanism defined in RFC 8110. Opportunistic Wireless Encryption (OWE) may use a hidden BSS if it has two BSSs, wherein one BSS is used for OWE-capable STAs and the other BSS is used for non-OWE-capable STAs.

In some embodiments, the AP may include information in the RNR regarding hidden BSSs that it operates at channel(s) other than the scanned channel, if the requested Short SSID, SSID or BSSID matches one of the hidden BSSs. The RNR may contain an element that indicates one or more of the following types of information. A one-bit hidden BSS field may be set to 1 to indicate that the reported BSS is hidden. In other words, the SSID may not be included in the multiple BSSID elements, and individually addressed unicast probe requests may be utilized to discover the BSS at the channel. Otherwise the field may be set to 0. The RNR may further comprise a one-bit OWE BSS field, which when set to 1 may indicate that the reported channel contains an OWE BSS that is a hidden BSS and uses OWE encryption. Otherwise, this field may be set to 0.

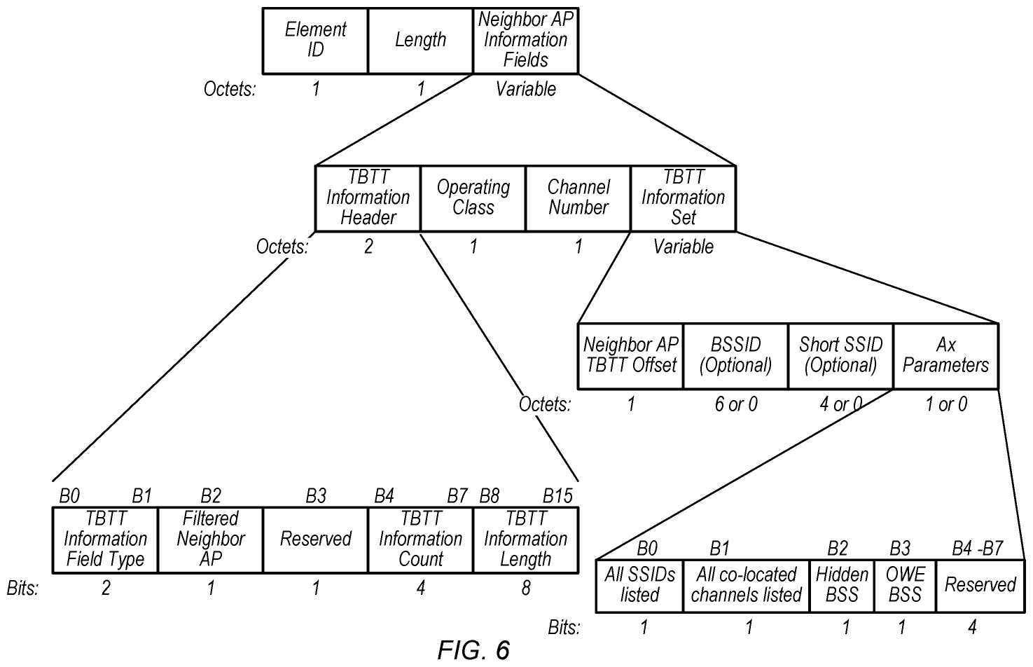

### FIG. 6—Example Reduced Neighbor Report Element Format

FIG. 6 illustrates an example format for a reduced neighbor report (RNR) element, according to some embodiments. While FIG. 6 illustrates one example of a format for the RNR element, other formats are also possible. For example, one or more of the elements illustrated in FIG. 6 may be omitted, as desired. As illustrated, a “Neighbor AP Information Fields” element of variable length may be appended to the RNR element. The “Neighbor AP Information Fields” element may contain a target beacon transmission time (TBTT) information header element, an operating class element, a channel number element, and a TBTT Information Set element. The TBTT information header element and the TBTT Information Set element may be further broken down into constituent elements, as illustrated. For example, the TBTT information set may comprise a single octet of auxiliary parameters comprises a single bit to indicate each of: whether all SSIDs serviced by the receiving AP are requested to be listed, whether all co-located channels are requested to be listed, whether a hidden BSS is requested, and/or whether an OWE BSS is requested.

In current implementations, an AP may transmit a multiple BSSID element in a probe response only from the transmit address of the BSS. A STA may be able to request a multiple BSSID element from an AP, even if the STA only knows the non-transmitted BSSID or a SSID matching to the AP. The probe request may contain a “MBSS Requested” field that may be set to 1 to request a probe response with a multiple BSSID element. When the AP receives a probe request with the “MBSS Requested” field set to 1, the AP may transmit a probe response with the receiver address (RA) of the MAC header set to the broadcast address and the transmitter address (TA) of the MAC header set to the transmit address of the co-located BSSs. Additionally or alternatively, a multiple BSSID element may be included in the probe response if the AP has two or more co-located BSSs and the requested BSSID or SSID of the probe request matches any of the BSSs associated with the AP.

When the AP receives a probe request with the “MBSS Requested” field set to 1, if the AP has only one co-located BSS, the AP may transmit a probe response with the transmitter address (TA) of the MAC header set to the requested BSSID or set to the BSSID of the BSS with the SSID matching the requested SSID.

When the AP receives a probe request with the “MBSS Requested” field set to 1, if the BSSID or SSID does not match with any of the BSS(s) associated with the AP, the AP may refrain from transmitting any response.

In some embodiments, a probe request may contain a “List all BSSs” field. This field may be set to 1 to indicate that the receiving AP is requested to list all BSSs upon which it operates, if it operates any BSS whose BSSID or SSID matches the BSSID or SSID, respectively, of the probe request. In these embodiments, the probe response transmitted in response to the probe request may include a list of two or more multiple BSSID elements, including all BSSs hosted by the AP and operating in the channel utilized for the probe request. The probe response may further include an RNR element including a SSID and/or a BSSID for all BSSs that are operated by the AP but not present in the multiple BSSID element. Additionally or alternatively, a RNR element may be included to list all primary channels of the BSSs. The AP may list the BSSIDs and SSIDs in these channels. In these embodiments, the information listed above may be requested to be listed. In other embodiments, the AP responds with information matching the requested SSID(s) or BSSID(s) and may select whether to include information of other BSSs.

In current implementations, probe requests may cause a surge of probe responses, leading to traffic congestion. For example, a probe request transmitted to a broadcast address allowing wild card SSID responses may get a probe response from all APs that received the request. In an area with a large number of APs, this may lead to a large number of probe responses being concurrently transmitted, and traffic congestion. Multiple probe requests may create a large quantity of management traffic and may cause poor quality of service in dense AP deployments. To reduce the number of probe requests and/or probe responses, the following traffic restrictions may be implemented. A probe request may be transmitted only if a STA has scanned a channel for a certain time and has not yet received any beacon frame or probe response providing the desired information. A broadcasted star/wildcard SSID probe request may not be allowed at the 6 GHz band. A single broadcast addressed probe response may be used to response to multiple probe requests. In general, these restrictions attempt to reduce scanning traffic without adding long delays to scanning.

Embodiments herein improve on these restrictions by introducing further techniques to reduce multi-BSS and multi-band probe traffic. In some embodiments, a STA may not transmit broadcast addressed probe request messages with a star/wildcard SSID that requests APs to list all BSSs that they operate in all channels. Further, an AP may not be allowed to respond to such a request. In some embodiments, an AP may be allowed to include all information it has in a probe response, even if the STA requests only a band specific response, such that other scanning STAs may be informed by a single broadcast probe response. In other words, the same broadcast information may serve multiple STAs. In some embodiments, in multi-band and multi-BSS queries, each AP may respond only to probe requests directed to the particular AP. In other words, APs may not respond on behalf of other APs.

It is currently under discussion whether 1 lax may use Access Network Query Protocol (ANQP) or On-Channel-Tunneling (OCT) as out-of-the band discovery mechanisms, to obtain probe response information from BSSs at other channels. The architecture of the ANQP and OCT differ from active scanning. For example, these protocols are typically much slower than active scanning. In some embodiments, the enhanced probe request and probe response messages described herein be used as a payload of these protocols.

In some embodiments, the ANQP query may carry probe response information to issue the probe request from APs operating in different bands. For example, the receiver address may be set to the AP that receives the ANQP query. The ANQP server may use this address to locate the neighboring APs. The requested BSSIDs and SSIDs may specify the requested BSSs. In some embodiments, a wildcard SSID may be used which may indicate that the probe response with a MBSSID element is requested from all neighboring BSSs. The ANQP response may return probe response frame content that is added to the operating class and the channel number of the responding AP. OCT may be utilized to tunnel a probe request message to a specific band addressed to a specific BSSID of the AP. If the AP matches with the probe request, the AP may tunnel back its probe response frame.

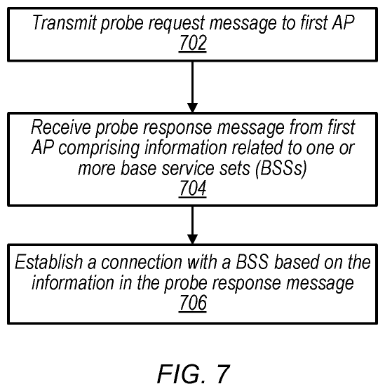

### FIGS. 7—Flowchart

FIG. 7 is a flowchart diagram illustrating a method for performing enhanced probe messaging over a wireless local area network, according to some embodiments. In some embodiments, the described methods may be performed between a wireless AP and a UE comprising a processing element operably coupled to a radio and an antenna. In various embodiments, some of the elements of the methods shown may be performed concurrently, in a different order than shown, may be substituted for by other method elements, or may be omitted. Additional method elements may also be performed as desired. As shown, the method may operate as follows.

At 702, the UE may transmit a probe request message to a first access point (AP) through a wireless local area network (WLAN). In some embodiments, the UE may transmit the probe request message directly to the first AP using an individual address (e.g, a MAC address) of the first AP. In other embodiments, the UE transmitting the probe request to the first AP may comprise the UE broadcasting the probe request, and the probe request may include an indication of which AP/APs is/are the intended recipient(s) of the probe request.

The probe request message may request one or more parameters of a response message. In some embodiments, the requested one or more parameters of the response message may comprise a service set identifier (SSID) of a first basic service set (BSS).

At 704, the UE may receive the response message from the first AP. In various embodiments, the response message may be comprised within a beacon message that was previously scheduled to be transmitted by the AP, or the response may comprise a separate probe response message. The response message may comprise information related to one or more BSSs. In some embodiments, the one or more BSSs are serviced by the first AP. The first BSS may be one of the one or more BSSs serviced by the first AP. The information related to the one or more BSSs may be determined at least in part based on the requested one or more parameters of the probe request message. The information related to the one or more BSSs may comprise a reduced neighbor report (RNR) element describing one or more channel properties of the first BSS. In some embodiments, the probe request message is carried within an Access Network Query Protocol (ANQP) message.

The first AP may comprise a multi-BSS AP, wherein the multi-BSS AP services a plurality of BSSs in different respective channels. In these embodiments, the information related to the one or more BSSs may comprise a multiple BSS identifier (BSSID) element, wherein the multiple BSSID element describes channel information of the plurality of BSSs serviced by the multi-BSS AP. In some embodiments, the response message further comprises an indication that the multiple BSSID element describes channel properties of all BSSs serviced by the wireless AP. In other embodiments, the probe request message may request information related to a specific set of one or more BSSs, and the response message may only describe channel properties of the specific set of one or more BSSs.

In some embodiments, the response message is transmitted within a first frequency band, and the one or more requested parameters of the response message comprise a request for channel information of a BSS operating in a second frequency band different from the first frequency band.

In some embodiments, the probe request message contains a service set identifier (SSID) of a hidden BSS, and the first AP comprises a multi-BSS AP that services the hidden BSS. In these embodiments, the response message may describe channel properties of the hidden BSS.

At 706, the UE may establish a connection with a first BSS of the one or more BSSs based at least in part on the information comprised within the response message. For example, the UE may establish a connection with the first BSS by utilizing one or more of an SSID or a frequency channel indicated as associated with the first BSS within the response message. Alternatively, the UE may store the information comprised within the response message, and may utilize this information in performing further scans and/or measurements before establishing a connection with the first BSS. For example, the UE may utilize the information in the response message to determine which APs, frequency bands, and/or RATs to scan and/or measure to determine signal quality, traffic conditions, before connecting to the first BSS. In other words, the response message may be utilized to direct the UE in further scans and/or measurements for selecting a desirable BSS (the first BSS) upon which to establish a connection.

### Summary

In summary, devices and methods are described for employing active scanning for more efficient multi-band and multi-BSS scanning. In some embodiments, active scanning may support out-of-the-band discovery and other protocols (ANQP or OCT) may not be needed. Alternatively, active scanning may be used compatibly with one or more of the ANQP or OCT protocols. A requesting STA may request to receive information on a specific SSID/BSSID on a single channel (e.g., the channel used to transmit the probe request), on all channels, or to get information on all available BSSs. APs may respond more efficiently to directed requests if the AP operates a matching BSS in another channel.

The following numbered paragraphs describe additional embodiments.

In some embodiments, a user equipment device (UE) comprises an antenna, a radio operably coupled to the antenna, and a processing element operably coupled to the radio. The antenna, radio, and processing element may be configured to transmit a probe request message to a first access point (AP) through a wireless local area network (WLAN), wherein the probe request message requests one or more parameters of a response message.

The antenna, radio, and processing element may be further configured to receive the response message from the first AP, wherein the response message comprises information related to one or more basic service sets (BSSs), and wherein the information related to the one or more BSSs is determined at least in part based on the requested one or more parameters of the probe request message.

The antenna, radio, and processing element may be further configured to establish a connection with a first BSS of the one or more BSSs based at least in part on the information comprised within the response message.

In some embodiments, the requested one or more parameters of the response message comprise parameters related to the first BSS, and the information related to the one or more BSSs comprises a reduced neighbor report (RNR) element identifying a first channel in which the first BSS operates, wherein the first channel is different from a second channel used to transmit the probe request message.

In some embodiments, the probe request message comprises a wildcard service set identifier (SSID) or a wildcard BSS identifier (BSSID), wherein the probe request message further comprises an SSID or a BSSID matching the one or more BSSs, and wherein the information related to the one or more BSSs comprises a reduced neighbor report (RNR) element describing one or more properties of the one or more BSSs.

In some embodiments, the probe request message indicates that the UE is capable of receiving a multiple BSS identifier (BSSID) element, wherein the first AP comprises a multi-BSS AP, wherein the multi-BSS AP services a plurality of BSSs, and wherein the information related to the one or more BSSs comprises the multiple BSSID element, wherein the multiple BSSID element describes information related to one or more of the plurality of BSSs serviced by the multi-BSS AP.

In some embodiments, the response message is transmitted from a first transmit media access control (MAC) address, and the requested one or more parameters of the response message specify a BSSID which is different from the first transmit MAC address

In some embodiments, the probe request message indicates that the UE is capable of receiving a multiple BSS identifier (BSSID) element, and wherein the probe request message comprises a wildcard service set identifier (SSID) or a wildcard BSS identifier (BSSID), the first AP comprises a multi-BSS AP that services a plurality of BSSs, and the information related to the one or more BSSs comprises the multiple BSSID element, wherein the multiple BSSID element describes information related to one or more of the plurality of BSSs serviced by the multi-BSS AP.

In some embodiments, the first AP comprises a multi-band AP operating in a plurality of frequency bands, and establishing a connection with the first BSS utilizes a first frequency band different from a second frequency band used to transmit the probe request message and the response message.

In some embodiments, the probe response message is transmitted within a first frequency band, and the one or more requested parameters of the probe response message comprise a request for channel information of a BSS operating in a second frequency band different from the first frequency band.

In some embodiments, the probe response message is transmitted within a first frequency band, and the one or more requested parameters of the probe response message comprise a request for information related to a BSS operating in the first frequency band.

In some embodiments, the probe request message contains a service set identifier (SSID) of a hidden BSS, the first AP services the hidden BSS, and the probe response message describes channel properties of the hidden BSS.

In some embodiments, the probe request message contains a service set identifier (SSID) of a BSS using Open Wireless Encryption (OWE), the first AP services the hidden BSS, and the probe response message describes channel properties of the OWE BSS.

In some embodiments, the probe request message is comprised within an Access Network Query Protocol (ANQP) message.

In some embodiments, the response message is one of a probe response message or a beacon message.

In some embodiments, a wireless access point (AP) comprises an antenna, a radio operably coupled to the antenna, and a processing element operably coupled to the radio. The wireless AP may be configured to receive a probe request message through a wireless local area network (WLAN) from a user equipment device (UE), wherein the probe request message requests one or more parameters of a response message.

In response to receiving the probe request message, the wireless AP may transmit the response message to the UE, wherein the response message comprises information related to one or more basic service sets (BSSs), and wherein the information related to the one or more BSSs is determined based at least in part on the requested one or more parameters.

In some embodiments, the probe response message comprises a multiple basic service set identifier (BSSID) element, wherein the multiple BSSID element describes channel properties of the one or more BSSs.

In some embodiments, the wireless AP comprises a multi-BSS AP, wherein the multi-BSS AP services a plurality of BSSs, and wherein the multiple BSSID element describes information of the plurality of BSSs of the multi-BSS AP.

In some embodiments, a first BSS of the one or more BSSs is serviced by the wireless AP, and the wireless AP is further configured to establish a connection with the UE through the first BSS.

In some embodiments, the one or more BSSs are serviced by the wireless AP, and the response message further comprises an indication that the response message contains one or both of a multiple BSS identifier (BSSID) elements and a reduced neighbor report (RNR) element that identify all service set identifiers (SSIDs) of the one or more BSSs.

In some embodiments, the response message further comprises an indication that the response message contains one or more RNR elements that identify one or more channels in which the wireless AP services BSSs.

In some embodiments, the requested one or more parameters of the response message comprise a service set identifier (SSID) of a first BSS of the one or more BSSs, and the response message further comprises a reduced neighbor report (RNR) element describing one or more channel properties of the first BSS.

In some embodiments, the response message is transmitted within a first frequency band, and the one or more requested parameters of the response message comprise requested channel information of a BSS operating in a second frequency band different from the first frequency band.

In some embodiments, the probe request message contains a service set identifier (SSID) or a BSS identifier (BSSID) of a hidden BSS, the wireless AP services the hidden BSS in a different channel from a channel in which it received the probe request message; and the response message describes channel properties of the hidden BSS.

In some embodiments, the probe request message contains a service set identifier (SSID) or a BSS identifier (BSSID) of an Open Wireless Encryption (OWE) BSS, the wireless AP services the OWE BSS in a different channel from a channel in which it received the probe request message, and the response message describes channel properties of the OWE BSS.

In some embodiments, the probe request message comprises a wildcard service set identifier (SSID) or a wildcard BSS identifier (BSSID), the probe request message further comprises an SSID or a BSSID matching one of the one or more BSSs, and the information related to the one or more BSSs comprises a reduced neighbor report (RNR) element describing one or more properties of the one or more BSSs.

In some embodiments, the probe request message indicates that the UE is capable of receiving a multiple BSS identifier (BSSID) element, the wireless AP comprises a multi-BSS AP, the multi-BSS AP services the one or more BSSs, and the information related to the one or more BSSs comprises the multiple BSSID element, wherein the multiple BSSID element describes information related to the one or more BSSs.

In some embodiments, the response message is transmitted from a first transmit media access control (MAC) address, and the requested one or more parameters of the response message specify a BSS identifier (BSSID) which is different from the first transmit MAC address.

In some embodiments, the wireless AP comprises a multi-band AP operating in a plurality of frequency bands, and the wireless AP is further configured to establish a connection with the UE using the first BSS through a first frequency band different from a second frequency band used to transmit the probe request message and the response message.

In some embodiments, the probe response message is transmitted within a first frequency band, and the one or more requested parameters of the probe response message comprise a request for information related to a BSS operating in the first frequency band.

In some embodiments, the probe request message is comprised within an Access Network Query Protocol (ANQP) message.

In some embodiments, the response message is either a probe response message or a beacon message.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106 or 107) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A user equipment device (UE), comprising:
an antenna;
a radio operably coupled to the antenna; and
a processing element operably coupled to the radio;
wherein the antenna, radio, and processing element are configured to:
transmit a probe request message to a first access point (AP) through a wireless local area network (WLAN), wherein the probe request message requests one or more parameters of a response message;
receive the response message from the first AP, wherein the response message comprises information related to one or more basic service sets (BSSs), and wherein the information related to the one or more BSSs is determined based at least in part on the requested one or more parameters of the probe request message; and
establish a connection with a first BSS of the one or more BSSs based at least in part on the information comprised within the response message.

2. The UE of claim 1,
wherein the requested one or more parameters of the response message comprise one or more parameters associated with the first BSS; and
wherein the information related to the one or more BSSs comprises a reduced neighbor report (RNR) element identifying a first channel in which the first BSS operates, wherein the first channel is different from a second channel used to transmit the probe request message.

3. The UE of claim 1,
wherein the probe request message comprises a wildcard service set identifier (SSID) or a wildcard BSS identifier (BSSID),
wherein the probe request message further comprises an SSID or a BSSID matching the one or more BSSs, and
wherein the information related to the one or more BSSs comprises a reduced neighbor report (RNR) element describing one or more properties of the one or more BSSs.

4. The UE of claim 1,
wherein the probe request message indicates that the UE is capable of receiving a multiple BSS identifier (BSSID) element,
wherein the first AP comprises a multi-BSS AP, wherein the multi-BSS AP services a plurality of BSSs, and
wherein the information related to the one or more BSSs comprises the multiple BSSID element, wherein the multiple BSSID element describes information related to one or more of the plurality of BSSs serviced by the multi-BSS AP.

5. The UE of claim 4,
wherein the response message is transmitted from a first transmit media access control (MAC) address, and
wherein the requested one or more parameters of the response message specify a BSSID which is different from the first transmit MAC address

6. The UE of claim 1,
wherein the probe request message indicates that the UE is capable of receiving a multiple BSS identifier (BSSID) element, and wherein the probe request message comprises a service set identifier (SSID) or a BSSID that matches with at least one BSS present in the multiple BSSID element;
wherein the first AP comprises a multi-BSS AP that services a plurality of BSSs, and
wherein the information related to the one or more BSSs comprises the multiple BSSID element, wherein the multiple BSSID element describes information related to one or more of the plurality of BSSs serviced by the multi-BSS AP.

7. The UE of claim 1,
wherein the first AP comprises a multi-band AP operating in a plurality of frequency bands;
wherein establishing a connection with the first BSS utilizes a first frequency band different from a second frequency band used to transmit the probe request message and the response message.

8. The UE of claim 1,
wherein the probe request message is transmitted within a first frequency band, and
wherein the one or more requested parameters of the probe request message comprise one or both of:
a request for channel information of a BSS operating in a second frequency band different from the first frequency band, and
a request for information related to a BSS operating in the first frequency band.

9. The UE of claim 1,
wherein the probe request message is comprised within an Access Network Query Protocol (ANQP) message.

10. A wireless access point (AP), comprising:
an antenna;
a radio operably coupled to the antenna; and
a processing element operably coupled to the radio;
wherein the wireless AP is configured to:
receive, from a user equipment device (UE), a probe request message through a wireless local area network (WLAN), wherein the probe request message requests one or more parameters to be included in a response message; and
responsive to the probe request message, transmit the response message to the UE, wherein the response message comprises information related to one or more basic service sets (BSSs), and wherein the information related to the one or more BSSs is determined based at least in part on the requested one or more parameters.

11. The wireless AP of claim 10,
wherein the wireless AP comprises a multi-BSS AP, wherein the multi-BSS AP services a plurality of BSSs,
wherein the probe response message comprises a multiple basic service set identifier (BSSID) element that includes information associated with one or more of the plurality of BSSs of the multi-BSS AP.

12. The wireless AP of claim 10, wherein a first BSS of the one or more BSSs is serviced by the wireless AP, and wherein the wireless AP is further configured to:
establish a connection with the UE through the first BSS.

13. The wireless AP of claim 10,
wherein the one or more BSSs are serviced by the wireless AP, and
wherein the response message further comprises an indication that the response message contains at least one of a multiple BSS identifier (BSSID) element or a reduced neighbor report (RNR) element that identifies all service set identifiers (SSIDs) of the one or more BSSs.

14. The wireless AP of claim 10,
wherein the probe request message is received and the response message is transmitted in a first frequency band, and
wherein the information related to the one or more BSSs comprises a service set identifier (SSID) or a BSS identifier (BSSID) of a BSS operating in a second frequency band different from the first frequency band.

15. The wireless AP of claim 10,
wherein the probe request message contains a service set identifier (SSID) or a BSS identifier (BSSID) of a first BSS, wherein the first BSS comprises a hidden BSS or an Open Wireless Encryption (OWE) BSS,
wherein the wireless AP services the first BSS in a different channel from a channel in which it received the probe request message; and
wherein the response message indicates one or more channel properties associated with the first BSS.

16. The wireless AP of claim 10,
wherein the probe request message comprises a wildcard service set identifier (SSID) or a wildcard BSS identifier (BSSID),
wherein the probe request message further comprises an SSID or a BSSID matching one of the one or more BSSs, and
wherein the information related to the one or more BSSs comprises a reduced neighbor report (RNR) element describing one or more properties of the one or more BSSs.

17. The wireless AP of claim 10,
wherein the wireless AP comprises a multi-BSS AP, wherein the multi-BSS AP services the one or more BSSs, and
wherein the information related to the one or more BSSs comprises a multiple BSS identifier (BSSID) element, wherein the multiple BSSID element describes information related to the one or more BSSs.

18. The wireless AP of claim 10,
wherein the response message is transmitted from a first transmit media access control (MAC) address, and
wherein the requested one or more parameters of the response message specify a BSS identifier (BSSID) that is different from the first transmit MAC address.

19. The wireless AP of claim 10,
wherein the wireless AP comprises a multi-band AP operating in a plurality of frequency bands,
wherein the wireless AP is further configured to:
establish a connection with the UE using the first BSS through a first frequency band that is different from a second frequency band used to transmit the probe request message and the response message.

20. A method for operating a wireless access point (AP), the method comprising:
receiving a probe request message through a wireless local area network (WLAN) from a user equipment device (UE), wherein the probe request message indicates one or more parameters to be included in a response message;
transmitting, responsive to the probe request message, the response message to the UE, wherein the response message comprises information related to one or more basic service sets (BSSs), wherein at least a first BSS of the one or more BSSs is serviced by the wireless AP, and wherein the information related to the one or more BSSs is determined based at least in part on the one or more parameters; and
establishing a connection with the UE through the first BSS.
